(19) United States
(12) Patent Application Publication
(10) Pub. No.: US 2012/0154951 A1
(43) Pub. Date: Jun. 21, 2012

(54) METHOD FOR MANUFACTURING A PERPENDICULAR MAGNETIC WRITE POLE HAVING A WRITE POLE AND TRAILING SHIELD WITH A TAPERED TRAILING GAP

(75) Inventors: Wen-Chien D. Hsiao, San Jose, CA (US); Fenglin Liu, Milpitas, CA (US); Aron Pentek, San Jose, CA (US); Yi Zheng, San Ramon, CA (US)

(73) Assignee: Hitachi Global Storage Technologies Netherlands B.V., Amsterdam (NL)

(21) Appl. No.: 12/975,010

(22) Filed: Dec. 21, 2010

(51) Int. Cl. G11B 5/187; G11B 5/255; G11B 5/127

(52) U.S. Cl. 360/122; 360/123.12; 427/130; G9B/5.051; G9B/5.04

(57) ABSTRACT

A method for manufacturing a magnetic write head having a that has a write pole with a tapered trailing edge in a pole tip region, and a trailing shield that has a leading edge that tapers away from the write pole at an angle that is greater than that taper angle of the trailing edge of the write pole. The magnetic head has a step feature with a front edge that is recessed from the ABS. In one embodiment a magnetic wedge is formed over the tapered surface of the write pole. In another embodiment, a non-magnetic bump is formed over a first tapered portion of the write pole adjacent to the front edge of the step feature, and a non-magnetic wedge is formed over a second tapered portion of the write pole and extends from the non-magnetic bump to the air bearing surface.

### FIELD OF THE INVENTION

The present invention relates to perpendicular magnetic write heads and more particularly to a method for manufacturing a magnetic write head for perpendicular magnetic recording that has a write pole with a tapered trailing edge and a tapered trailing gap.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head can include a magnetic write pole and a magnetic return pole, the write pole having a much smaller cross section at the ABS than the return pole. The magnetic write pole and return pole are magnetically connected with one another at a region removed from the ABS. An electrically conductive write coil induces a magnetic flux through the write coil. This results in a magnetic write field being emitted toward the adjacent magnetic medium, the write field being substantially perpendicular to the surface of the medium (although it can be canted somewhat, such as by a trailing shield located near the write pole). The magnetic write field locally magnetizes the medium and then travels through the medium and returns to the write head at the location of the return pole where it is sufficiently spread out and weak that it does not erase previously recorded bits of data.

A magnetoresistive sensor such as a GMR or TMR sensor can be employed for sensing magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

### SUMMARY OF THE INVENTION

The present invention provides a method for manufacturing a magnetic write head having a write pole with a tapered trailing edge and a trailing magnetic shield with a leading edge that tapers away from the magnetic write pole at an angle that is greater than the taper angle of the trailing edge of the write pole.

The method includes forming a write pole and forming a stepped feature over the write pole, the stepped feature having a front edge that is recessed from the air bearing surface. A first ion milling is performed to form a tapered surface on the trailing edge of the write pole. A non-magnetic material is deposited and a second ion milling is performed to form a non-magnetic material into a non-magnetic wedge that extends from the non-magnetic step to the air bearing surface. A trailing magnetic shield is formed over the non-magnetic wedge and the step feature to form a trailing shield having a leading edge taper angle that is greater than the taper angle of the magnetic write pole.

Forming the trailing shield with a greater taper angle than the magnetic write pole allows the shield to write pole spacing to increase with increasing distance from the ABS, and this increasing distance advantageously begins right from the air bearing surface. This structure provides optimal performance in preventing flux loss to the trailing shield, while also providing optimal write field gradient increase.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view of a magnetic head, taken from line 3-3 of FIG. 2 and rotated 90 degrees counterclockwise, of a magnetic head according to an embodiment of the present invention;

FIG. 4, is an enlarged view of a portion of a write head according to a first embodiment of the invention;

FIG. 5 is an enlarged view of a portion of a write head according to a second embodiment of the invention;

FIGS. 6-16, are views of a write head in various intermediate stages of manufacture, illustrating a method for manufacturing a write head according to an embodiment of the invention; and

FIGS. 16-21 are views of a write head in various intermediate stages of manufacture illustrating a method for manufacturing a write head according to an alternate embodiment of the invention.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

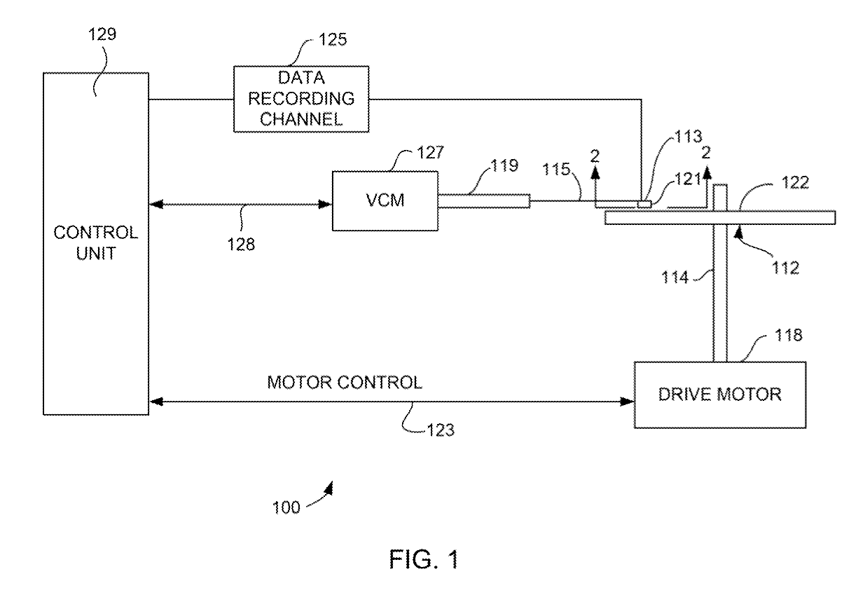

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

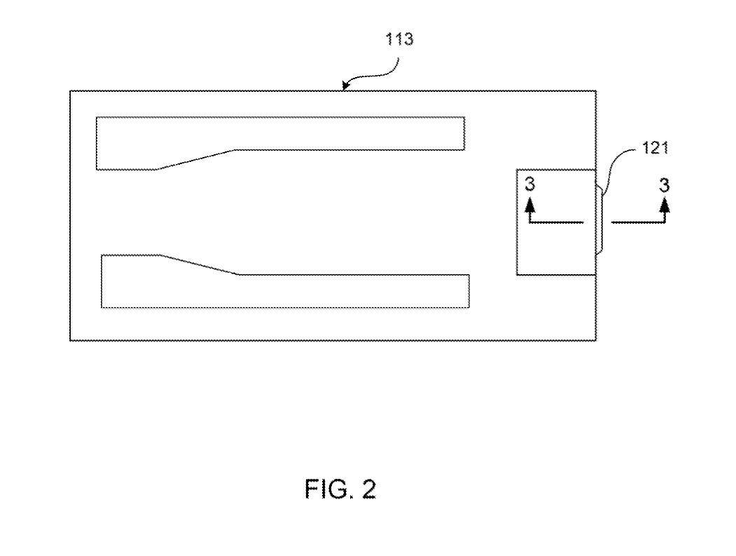

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

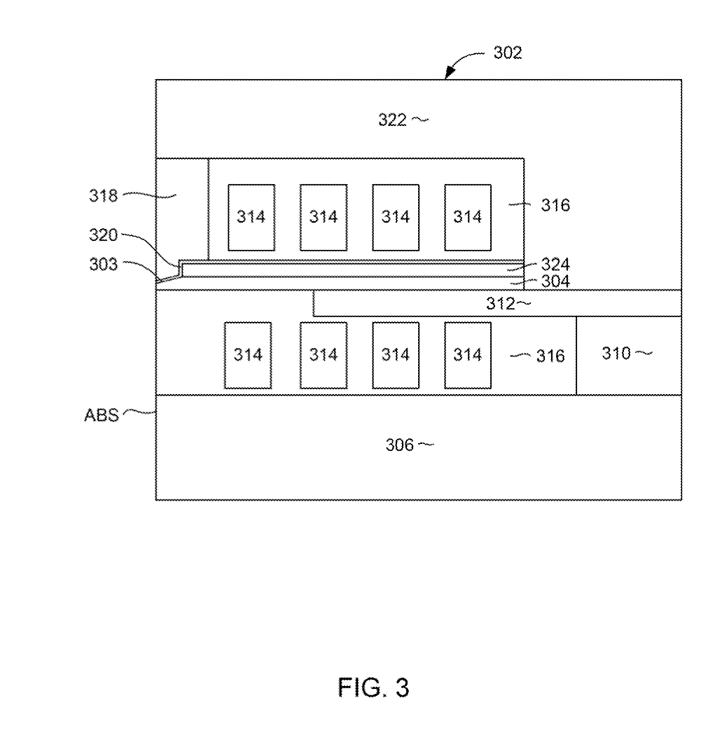

With reference now to FIG. 3, the invention can be embodied in a magnetic head 302, which is formed upon the trailing edge of the slider 113 (FIG. 2). The write head 302 includes a magnetic write pole 304 and a magnetic return pole 306. The return pole 306 has a cross section at the air bearing surface (ABS) that is much greater than the cross section of the write pole 304 at the ABS. The write pole 304 and return pole 306 are connected with one another in a region removed from the ABS by a magnetic back gap layer 310, and by a magnetic shaping layer 312 that connects the back gap 310 with the write pole 304 and channels magnetic flux to the smaller write pole 304. The return pole 306, back gap 310 and shaping layer 312 can each be constructed of a magnetic material such as CoFe. The write pole 304 can be a lamination of magnetic layers such as CoFe separated by thin layers of non-magnetic material. This laminated write pole structure is made possible by a process described below, and is helpful in reducing eddy currents in the write pole and increasing magnetic switching speed within the write pole 304.

A non-magnetic, electrically conductive write coil 314, shown in cross section in FIG. 3, passes between the write pole 304 and the return pole 306, and preferably also passes above the write pole 304. The write coil can be embedded in a non-magnetic, electrically insulating layer 316 such as one or more layers of alumina and or hard baked photoresist.

When a current flows through the write coil 314, the resulting magnetic field causes a magnetic flux to flow through the return pole 306, back gap layer 310 shaping layer 312 and write pole 304. That results in a magnetic write field being emitted from the tip of the write pole 304 at the ABS. Because the write pole 304 has a small cross section at the ABS, the write field is dense and strong and can write a magnetic bit to a magnetic medium passing by the ABS of the write head 302. This magnetic write field passes through the magnetic medium before returning to the return pole 306. Because the return pole 306 has a much larger cross section at the ABS, the magnetic field returning to the return pole 306 is sufficiently spread out and weak that it does not erase the previously recorded bit.

In order to increase the field gradient of the magnetic field emitted from the write pole, and thereby increase the write speed, a magnetic trailing shield 318 is formed adjacent to the trailing edge of the write pole 304. The trailing magnetic shield 318 can be magnetically connected with the rest of the magnetic structure at the back of the write head 302 by a trailing return pole structure 322. The trailing magnetic shield 318 is separated from the write pole 304 by a non-magnetic trailing gap layer 320. Further magnetic spacing between the trailing shield 318 and the write pole at a location removed from the ABS by a non-magnetic step layer 324, the construction of which will be described in greater detail herein below. The step layer 324 can also be constructed of a magnetic material, in which case the step layer 324 serves to increase the effective thickness of the write pole 304 in a region slightly removed from the ABS in order to better channel magnetic flux to the tip of the write pole 304.

It can also be seen in FIG. 3 that the write pole 304 has a tapered trailing edge 303. This tapering at the pole tip region of the write pole 304 improves magnetic performance by channeling magnetic flux to the write pole tip. This maximizes write field density, avoids saturation of the pole tip of the write pole 304 and maximizes write field strength.

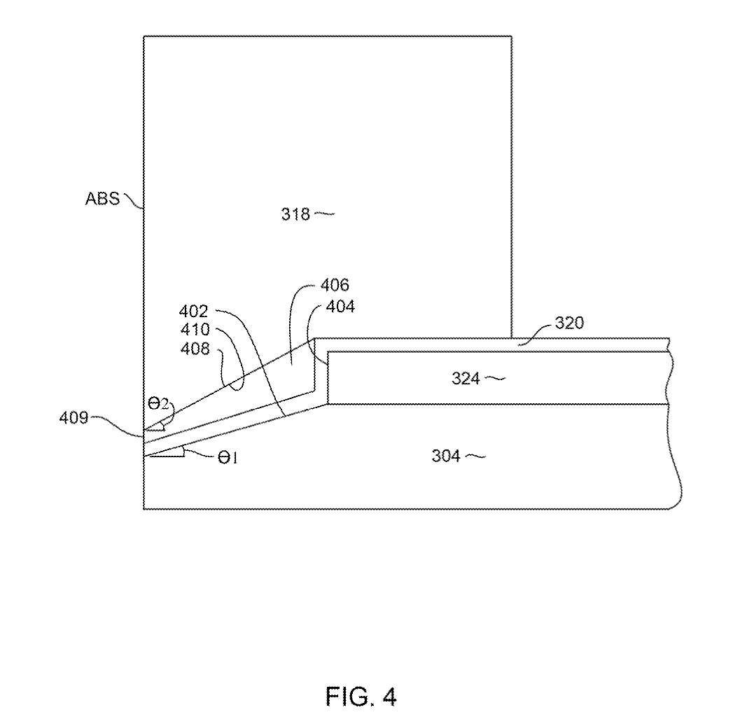

FIG. 4 shows an enlarged view of a pole tip region of the head 302 according to one embodiment of the invention. In this embodiment, the write pole 304 has a tapered trailing edge portion 402. The trailing edge 402 has a constant taper at a first angle □1 relative to a plane that is perpendicular with the ABS (and parallel with the planes of the as deposited layers of the write head 302). The head 302 includes the non-magnetic trailing gap layer 320 which is preferably a layer of alumina, deposited by a conformal deposition process such as atomic layer deposition (ALD). The non-magnetic trailing gap layer 320 can have a thickness of 10-30 nm or about 20 nm. The non-magnetic step layer 324 can be constructed of one or more layers of non-magnetic material such as NiCr and or SiC. The non-magnetic step 324 has a front edge 404 that is recessed a desired amount from the air bearing surface (ABS). The construction and makeup of this layer will be better understood after reading a following description of a method of manufacturing a write head according to an embodiment of the invention. The tapered trailing edge 402 extends from the ABS to the front edge 404, and the non-magnetic trailing gap layer 320 extends over this front edge 404.

The write head also includes a tapered non-magnetic spacer layer 406. The non-magnetic spacer 406 has a tapered trailing edge 408 that also defines a tapered leading edge 410 of the shield 318. The trailing edge 408 of the non-magnetic layer 406 forms an angel □2 that is also measured perpendicular to the ABS and parallel with the planes of the as deposited layers of the head 302. The angle □2 is larger than the angle □1. In this way, the tapered leading edge 410 of the shield tapers away from the leading edge 402 of the write pole 304 by a distance that increases with increasing distance from the ABS. The tapered trailing edge 408 and non-magnetic wedge 406 extend all of the way to the ABS. As shown in FIG. 4, the non-magnetic wedge 406 preferably terminates at the ABS before coming to a point so that the wedge forms a small flat surface 409 at the ABS. The significance of this will become clearer upon reading a method of manufacturing a write head as described herein below. This structure advantageously provides an optimal shield/write pole spacing form maximizing write field strength and field gradient while minimizing the loss of magnetic write field to the shield 318. This structure can be manufactured by a method that will be described in greater detail herein below.

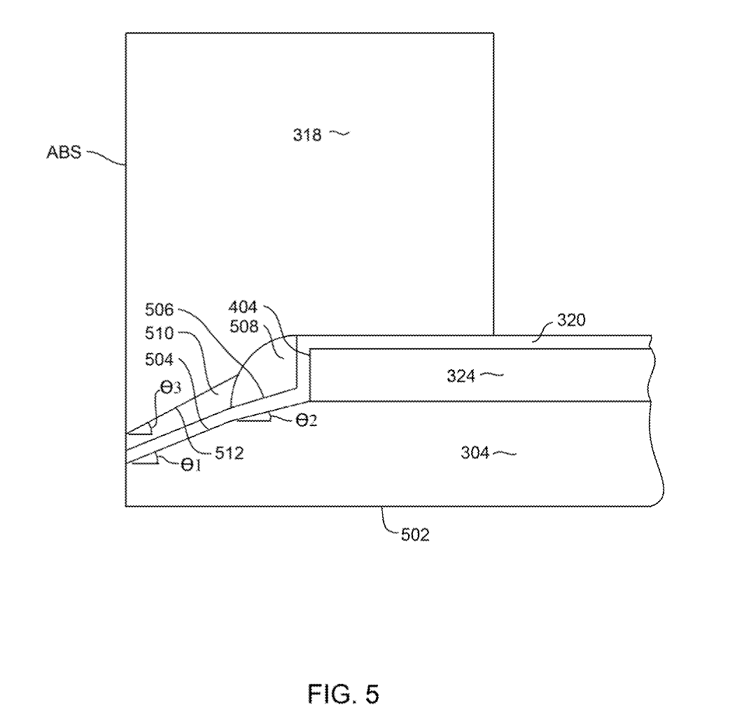

FIG. 5 shows an enlarged view of a pole tip portion of a write head 502 according to another embodiment of the invention. In this embodiment, the write pole has a multi-angle, tapered trailing edge portion having a first tapered portion 504 located closest to the air bearing surface (ABS) and defining an angle □1 and a second tapered portion 506 that is more removed from the ABS and which defines an angle □2 which is shallower than □1. As with the previously described embodiment 302, the head 502 of FIG. 5 includes a step feature 324 having an end 404 that is recessed from the ABS.

The head 502 also includes a non-magnetic bump feature 508 formed at the front edge 404 of the step 324. The non-magnetic bump 508 terminates at a desired location between the front edge 404 of the step 324 and the ABS. A non-magnetic tapered wedge layer 510 extends from the non-magnetic bump 508 to the ABS, as shown. Although referred to as a non-magnetic wedge 510, this wedge does not actually come to a point at the ABS, but actually forms a flat surface at the ABS and has a thickness at the ABS that is chosen to define a trailing gap thickness. Also, as can be seen in FIG. 5, the termination point of the non-magnetic bump 508 defines and controls the location of the junction between the first tapered portion 504 and the second tapered portion 506. The shield 318 has a tapered leading edge 512 that is defined by the non-magnetic tapered layer 510 and the non-magnetic bump 508. This leading edge 512 defines an angle □3 that is greater than the angles □1 and □2. These angles □1, □2, □3 are measured from a plane that is perpendicular with the air bearing surface (ABS) and parallel with the planes of the as deposited layers of the write head.

As with the previously described embodiment, the non-magnetic tapered wedge 510 and its trailing edge extend to the ABS, and preferably terminate without forming a point, such that the wedge 510 forms a small flat surface 509 at the ABS. This wedge 510 this causes the spacing between the shield 318 and the write pole 304 to increase with increasing distance from the ABS. A major difference between this embodiment and the previously described embodiment is, of course, the fact that in this embodiment, the angle of the tapered portions 504, 506 changes, whereas the taper is relatively constant in the embodiment shown in FIG. 4. This is the result of a manufacturing process that will be described in greater detail herein below.

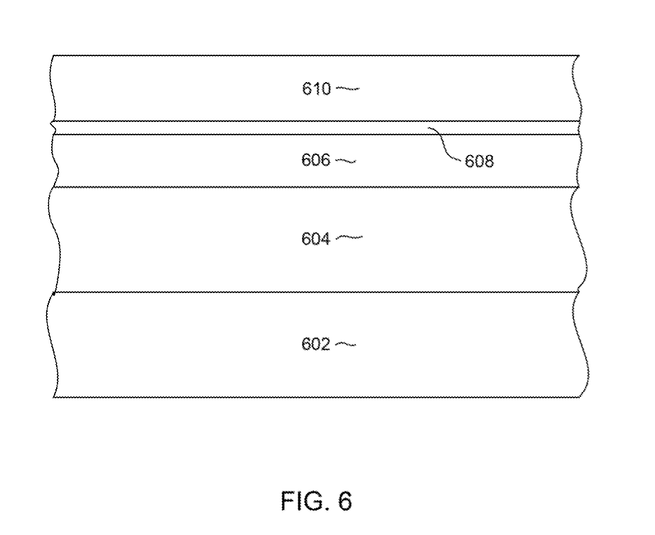

FIGS. 6-16 illustrate a method for manufacturing a write head according to an embodiment of the invention, such as the write head 302 shown in FIG. 4. With particular reference to FIG. 6, a substrate 602 is provided and a layer of write pole material 604 is deposited over the substrate. The substrate 602 can include a planarized alumina fill layer 316 and all or a portion of the shaping layer 312 both of which were described above with reference to FIG. 3. The write pole material layer 604 can be a plurality of high Bsat magnetic layers such as CoFe separated by thin non-magnetic layers. A non-magnetic step material 606 such as SiC is deposited over the magnetic write pole layer 604. The layer 606 can be 100-300 nm thick. A hard mask layer 608 such as Cr or NiCr is deposited over the step layer 606. The hard mask layer can be deposited to a thickness of 10-30 nm. Finally, a photoresist layer 610 is deposited over the hard mask layer 608.

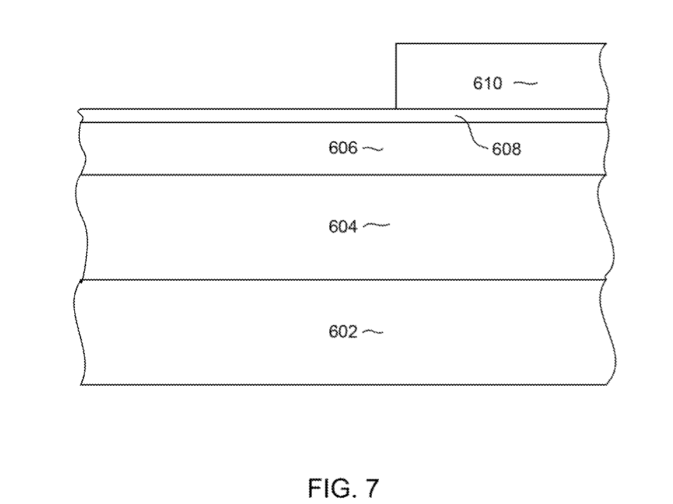

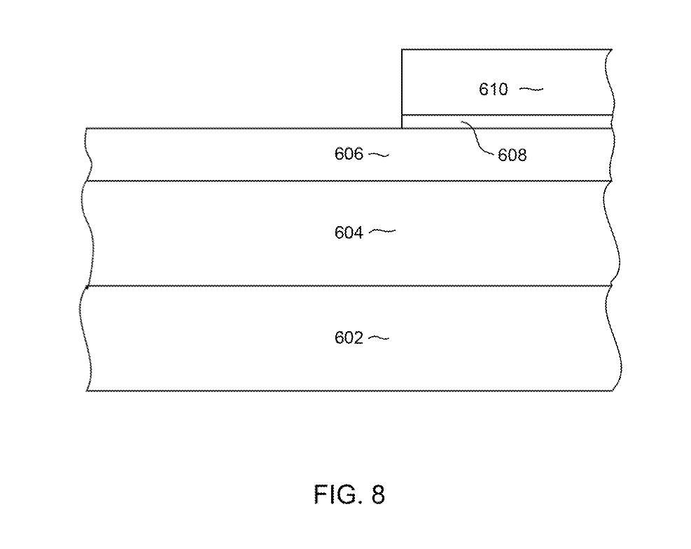

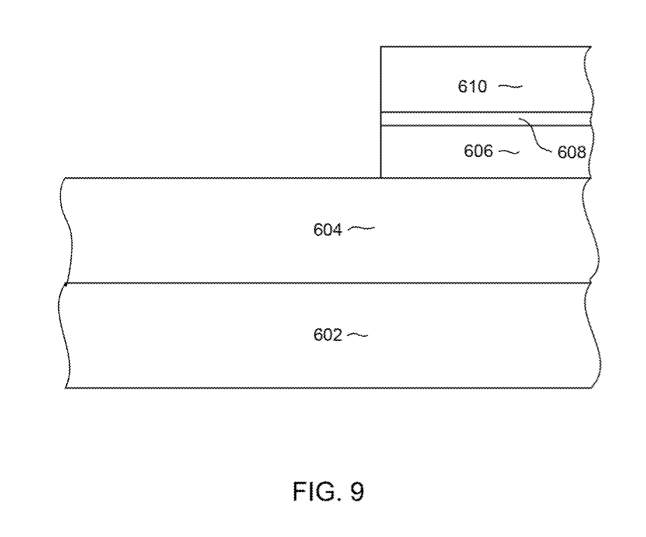

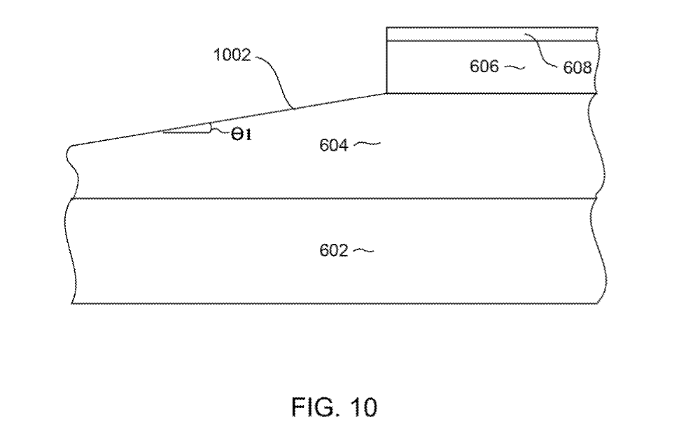

Then, with reference to FIG. 7, the photoresist layer 610 is photolithographically patterned and developed to form a mask having a desired shape for defining the underlying step layer 606 and hard mask 608. An ion milling is then performed to transfer the image of the photoresist mask 610 onto the underlying hard mask layer 608, leaving a structure as shown in FIG. 8. A reactive ion etching (RIE) is then performed to transfer the image of the hard mask structure 608 onto the underlying step layer 606, leaving a structure such as that shown in FIG. 9. A second ion milling is then performed to remove a portion of the magnetic write pole material 604 that is not covered by the step layer 606. This ion milling is performed at one or more angles relative to normal so that shadowing from the step layer 606 and hard mask layer 608 causes the ion milling to form a tapered surface 1002 on the magnetic write pole layer as shown in FIG. 10. The thickness of the layers 606, 608 and the angle of ion milling can be adjusted to achieve a desired taper angle on the tapered surface 1002. The tapered surface 1002 preferably defines an angle □1 of 10-30 degrees or about 20 degrees relative to the planes of the as deposited layers.

The above processes described with reference to FIGS. 6-10 illustrate one possible way to form a write pole layer 604 with a tapered surface 1002 and step layer 606 and mask 608. In an alternate process (beginning with a structure as shown in FIG. 7), the step layer 606 can be constructed of a material such as Ta, or carbon (e.g. diamond like carbon (DLC)). The hard mask layer can be constructed of a material such as Ru or NiCr. A reactive ion etching (RIE) is then performed to transfer the image of the photoresist layer 610 onto the underlying hard mask layer 608, leaving a structure as shown in FIG. 8. An ion milling is then performed to transfer the image of the hard mask layer 608 onto the underlying step layer 606, leaving a structure as shown in FIG. 9. The ion milling can then be continued to remove a portion of the write pole material to form the tapered surface 1002 shown in FIG. 10, although the angle of the ion milling may be changed between the steps of FIG. 9 and FIG. 10.

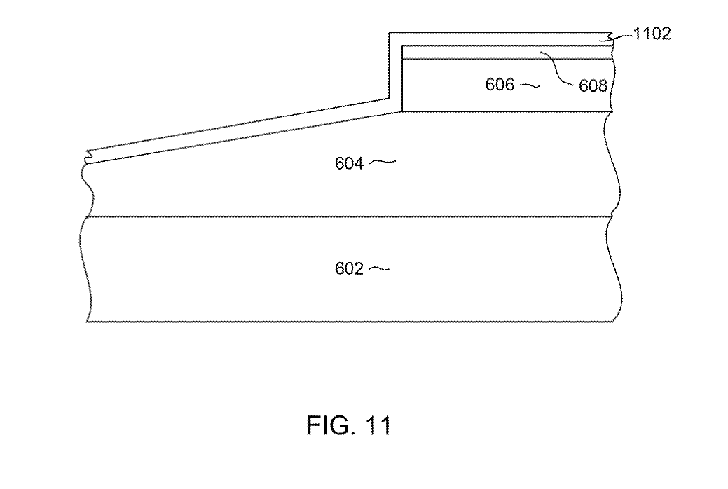

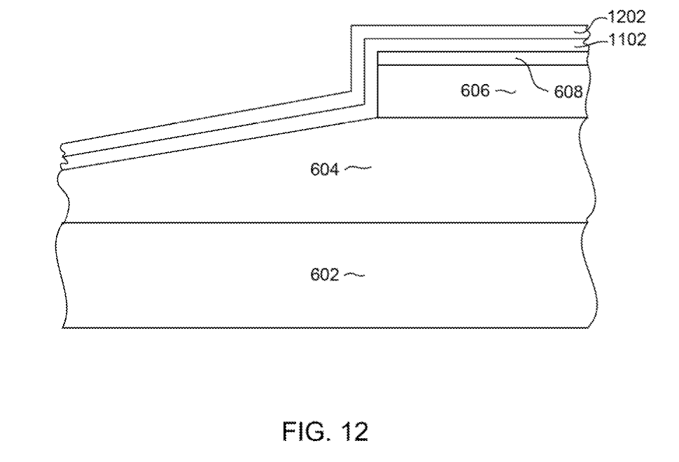

With reference now to FIG. 11, a non-magnetic trailing gap layer 1102 is deposited. This can be a layer of alumina, deposited to a desired thickness by a conformal deposition process such as atomic layer deposition (ALD). This layer 1102 is preferably deposited to a thickness of 10-30 nm or about 20 nm. Then, with reference to FIG. 12, a layer of Ru 1202 is deposited over the write gap layer 1102. The Ru layer 1202 is also preferably deposited by a conformal deposition process such as atomic -layer deposition, and is preferably deposited to a thickness of 20-40 nm or about 30 nm.

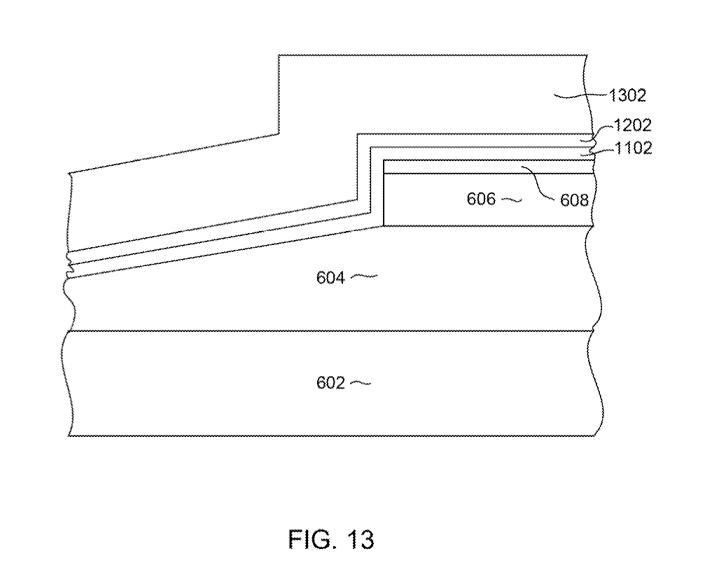

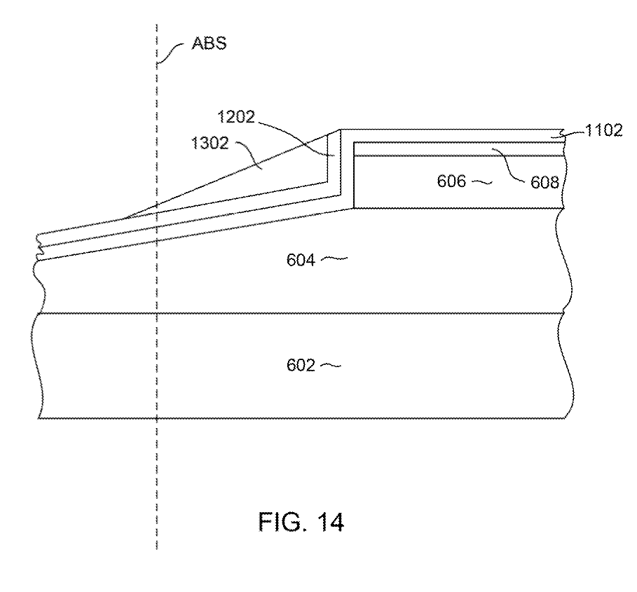

Then, with reference to FIG. 13, a relatively thick layer of alumina 1302 is deposited. This layer 1302 is also preferably deposited by a conformal deposition process such as atomic layer deposition, and is preferably deposited to a thickness of 50-70 nm or about 60 nm. A multi-angle ion milling is then performed to remove a portion of the layers 1302 and 1202 to form a tapered non-magnetic wedge layer as shown in FIG. 14. The write gap layer 1102 acts as a stop layer to help determine when the ion milling should be terminated. (Yi is this right?)

In FIG. 14, an intended air bearing surface plane is designated by a dashed line designated as ABS. As will be appreciated by those skilled in the art, the air bearing surface is not yet formed at this stage of manufacture, but will be later formed by a slicing and lapping process after the magnetic head had been formed on a wafer. The previously described ion milling is performed so that the non-magnetic wedge 1302 extends beyond the ABS plane. Extending the wedge 1302 to a point beyond the ABS plane ensures that the tapered surface of the wedge 1302 will extend all of the way to the ABS even in light of process variations and deviations such as in the lapping process used to define the ABS.

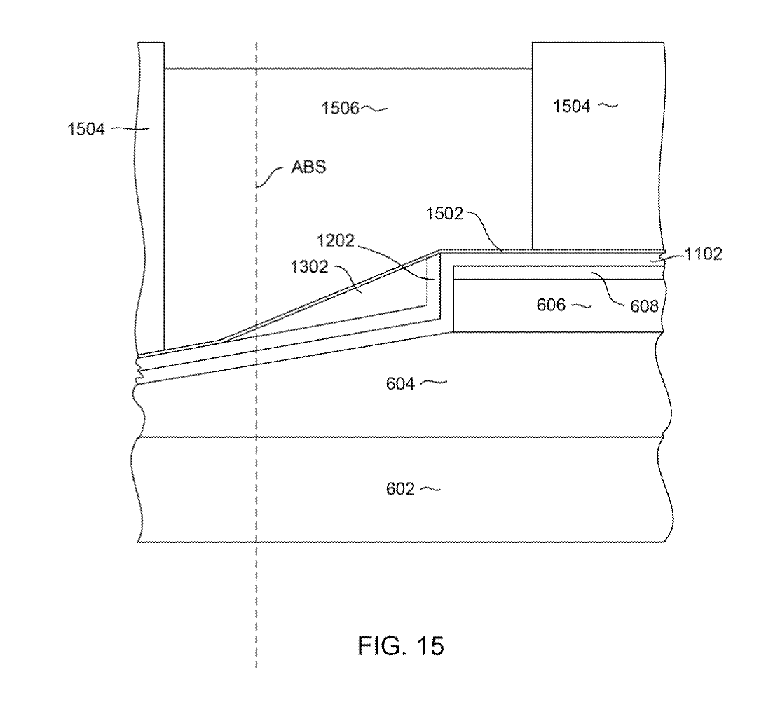

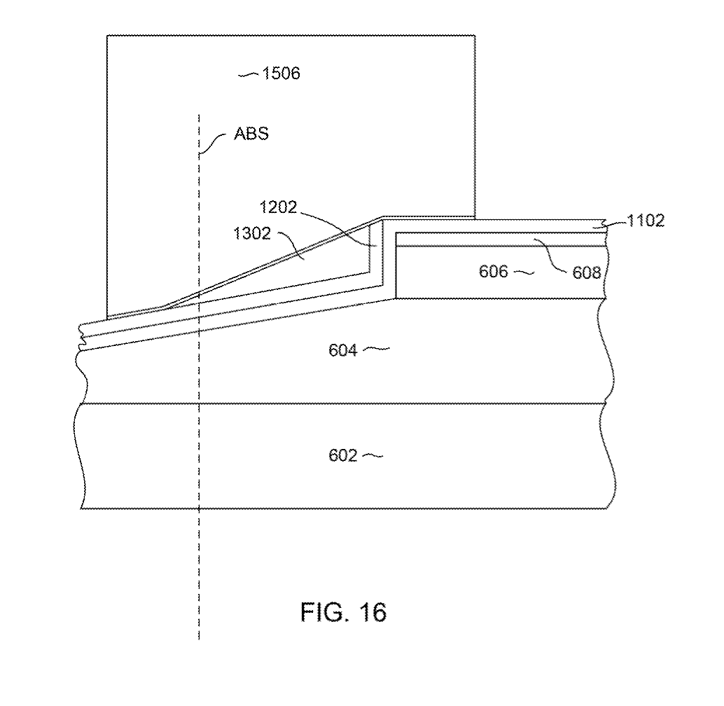

Then, with reference to FIG. 15, a seed layer 1502 is deposited. The seed layer 1502 can be an electrically conductive material such as NiFe, CoFe or CoNiFe. An electroplating frame mask 1504 is deposited having an opening that is configured to define a trailing magnetic shield. A magnetic material 1506 is then electroplated into the opening to form a trailing magnetic shield. Then, the electroplating frame mask is removed and a quick ion milling or reactive ion etching is performed to remove portions of the seed layer 1502 that are not protected by the magnetic shield layer 1506, leaving a structure such as that shown in FIG. 16, which corresponds with the structure shown in FIG. 4.

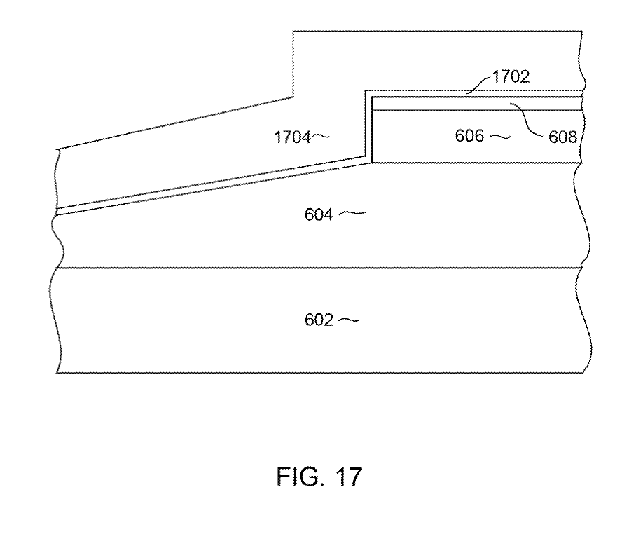

FIGS. 17-21 illustrate a method for manufacturing a write head, such as the write head described above with reference to FIG. 5. Starting with a structure such as that described above with reference to FIG. 10, a layer of AlTiO 1702 is deposited, followed by a thicker layer of alumina 1704. Both layers are preferably deposited by a conformal deposition process such as atomic layer deposition. The layer 1702 is preferably deposited to a thickness of 3-10 nm or about 5 nm, and the layer 1704 is preferably deposited to a thickness of 90-110 nm or about 100 nm.

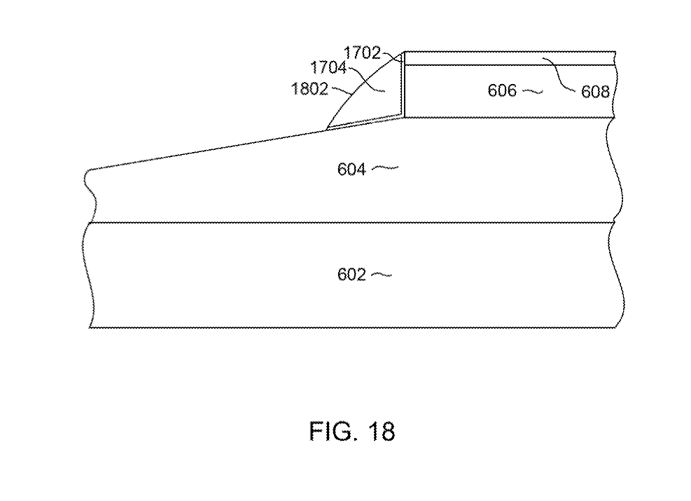

An ion milling is then performed to remove a portion of the layers 1702, 1704 to form a non-magnetic bump 1802 as shown in FIG. 18. The bump 1802 includes a portion of the layer 1702 and also layer 1704, but will be referred to hereafter simply as bump 1802 for purposes of simplicity. The ion milling is performed at one or more angles relative to normal so that shadowing from the step layer 606 allows the ion milling to form the non-magnetic bump as shown in FIG. 18. In addition to forming this bump, the ion milling is performed sufficiently to remove a further portion of the write pole material 604 to increase the steepness of the taper angle for portion of the write pole 604 that are not disposed beneath the bump 1802 or step 606.

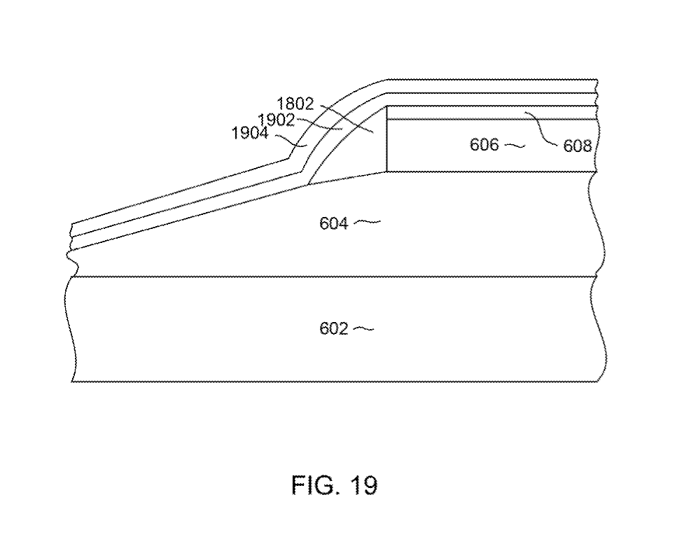

With reference to FIG. 19, a layer of alumina Al₂O₃ 1902 is deposited followed by a layer of Ru 1904. Both the alumina 1902 and Ru layer 1904 are preferably deposited by atomic layer deposition (ALD). The combined thickness of layers 1902, 1904 is preferably 20-40 nm or about 30 nm. Alternatively, the alumina layer 1904 could be eliminated so that only a layer of Ru having a thickness of 20-40 nm or about 30 nm is deposited.

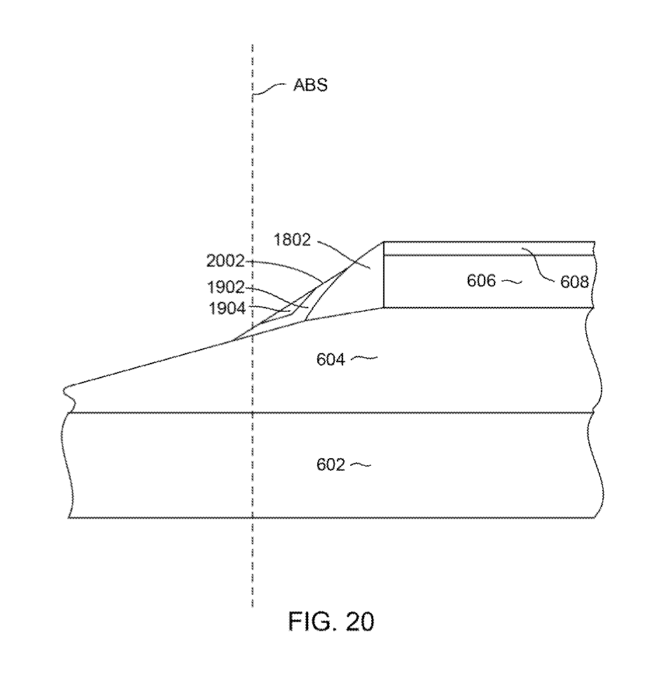

Then, a multi-angle ion milling is performed to remove a portion of the layers 1902, 1904, leaving a non-magnetic tapered wedge as shown in FIG. 20. If an alumina layer 1902 is used, this layer can act as a stop layer for the ion milling process. This ion milling is preferably performed so as to form the surface 2002 that defines an angle of 25 to 35 degrees with respect to the plane of the as deposited layers. The tapered surface 2002 extends slightly beyond the air bearing surface plane ABS ensuring that after lapping, the surface 2002 will extend to the ABS.

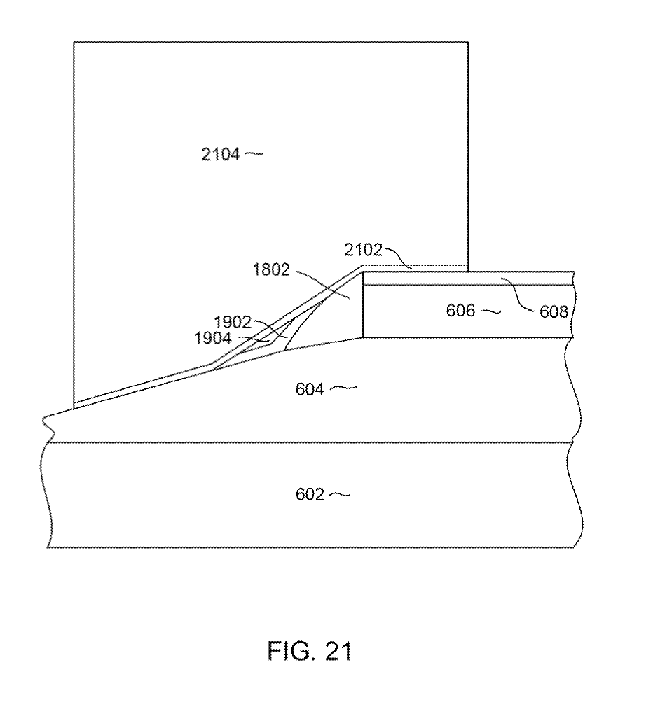

Then, as shown in FIG. 21 a magnetic trailing shield 2104 can be electroplated on an electrically conductive, non-magnetic seed layer 2102 as described above with reference to FIGS. 15 and 16.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetic write head, comprising:
forming a magnetic write pole material having a step feature formed thereover, the step feature having a front edge located at a desired distance from an air bearing surface plane, the write pole material having a tapered surface that extends from the front edge of the step feature at least to the air bearing surface plane;
depositing a non-magnetic trailing gap material write gap layer;
depositing a non-magnetic wedge material over the trailing gap layer;
performing an ion milling to form non-magnetic wedge having a tapered surface that extends at least to the intended air bearing surface plane and that extends in an opposite direction no further than the front edge of the step feature; and
forming a magnetic shield over the non-magnetic wedge.

2. The method as in claim 1 wherein the step feature is non-magnetic.

3. The method as in claim 1 wherein the depositing a non-magnetic wedge material comprises depositing a layer of Ru followed by a thicker layer of alumina.

4. The method as in claim 1 wherein the depositing a non-magnetic wedge material comprises depositing a layer of Ru having a thickness of 20-40 nm and then depositing a layer of alumina having a thickness of 50-70 nm.

5. The method as in claim 1 wherein the tapered surface of the write pole forms an first angle relative to a plane that is perpendicular to the air bearing surface the intended air bearing surface and the tapered surface of the non-magnetic wedge forms a second angle relative to a plane that is perpendicular to the air bearing surface, the first angle being smaller than the second angle.

6. The method as in claim 5 wherein the first angle is 10-30 degrees and the second angle is 25-30 degrees.

7. A method for manufacturing a magnetic write head, comprising:
forming a magnetic write pole material having a step feature formed thereover, the step feature having a front edge located at a desired distance from an air bearing surface plane, the write pole material having a tapered surface that extends from the front edge of the step feature at least to the air bearing surface plane;
depositing a non-magnetic bump material;
performing a first ion milling to remove a portion of the non-magnetic bump on the front edge of the step feature and over a portion of the tapered surface of the write pole, the bump terminating short of the intended air bearing surface plane;
depositing a non-magnetic wedge material;
performing a second ion milling to remove a portion of the non-magnetic wedge material to form non-magnetic wedge that has a tapered surface that extends from the non-magnetic bump to a point beyond the intended air bearing surface; and
forming a magnetic shield over the non-magnetic wedge, non-magnetic bump and over at least a portion of the step layer.

8. The method as in claim 7 wherein the depositing a non-magnetic bump layer comprises depositing alumina.

9. The method as in claim 7 wherein the depositing a non-magnetic bump layer comprises depositing alumina and AlTiO.

10. The method as in claim 7 wherein the depositing a non-magnetic wedge material comprises depositing a layer of Ru.

11. The method as in claim 7 wherein the depositing a non-magnetic wedge material comprises depositing a layer of Ru and a layer of alumina.

12. A magnetic write head, comprising:
a magnetic write pole having a tapered trailing edge in a pole tip region, the tapered trailing edge forming a first angle with respect to a plane that is perpendicular with an air bearing surface;
a step feature formed on the write pole, the step feature having a front edge that is recessed from the air bearing surface, the tapered trailing edge of the pole extending from the front edge of the step feature to the air bearing surface;
a non-magnetic trailing gap layer formed over the step feature, the front edge of the step feature and the tapered trailing edge of the write pole;
a non-magnetic wedge having a tapered trailing surface that defines a second angle with respect to a plane that is perpendicular with the air bearing surface, the second angle being greater than the first angle, the non-magnetic wedge being bounded between the front edge of the step feature and the air bearing surface; and
a magnetic shield formed over the non-magnetic wedge and at least a portion of the step feature.

13. The magnetic write head as in claim 12 wherein the non-magnetic wedge is separated from the front edge of the step feature by the non-magnetic trailing gap layer.

14. The magnetic write head as in claim 12 wherein the magnetic shield is separated from the step feature by the non-magnetic trailing gap layer.

15. The magnetic write head as in claim 12 wherein the step feature is non-magnetic.

16. The magnetic write head as in claim 12 wherein the tapered trailing surface of the non-magnetic wedge extends to the air bearing surface.

17. The magnetic write head as in claim 12 wherein the non-magnetic wedge comprises Ru and alumina.

18. The magnetic write head as in claim 12 wherein the first angle is 10-30 degrees and the second angle is 25 to 35 degrees.

19. The magnetic write head as in claim 12 wherein the first angle is about 20 degrees and the second angle is 25 to 35 degrees.

20. A magnetic write head, comprising:
a magnetic write head, comprising:
a magnetic write pole having a tapered trailing edge in a pole tip region, the tapered trailing edge having a first tapered portion with a trailing surface formed at a first angle relative to a plane that is perpendicular with an air bearing surface and second tapered portion having a surface formed at a second angle relative to a plane that is perpendicular to the air bearing surface the second angle being larger than the first angle;
a magnetic step feature formed over the magnetic write pole and having a front edge that is recessed from the air bearing surface;
a non-magnetic bump adjacent to the front edge of the step feature and formed over the first tapered portion of the write pole; and
a non-magnetic wedge layer formed over the second tapered portion of the write pole; and
a magnetic shield formed over the non-magnetic wedge, non-magnetic bump and step feature.

21. The magnetic write head as in claim 20 wherein the step feature is non-magnetic.

22. The magnetic write head as in claim 20 wherein the non-magnetic wedge extends from the non-magnetic bump to the air bearing surface.

23. The magnetic write head as in claim 20 wherein the magnetic shield has a leading edge formed over the non-magnetic wedge, the leading edge defining a third angle relative to a plane that is perpendicular to the air bearing surface the third angle being greater than the first angle and second angle.

24. The magnetic write head as in claim 20 wherein the wedge forms a flat end at the air bearing surface and has a thickness at the air bearing surface that is chosen to define a desired trailing gap thickness.
